(19) United States
(12) Patent Application Publication
(10) Pub. No.: US 2003/0219113 A1
(43) Pub. Date: Nov. 27, 2003

(54) Echo canceller with double-talk and channel impulse response adaptation

(76) Inventors: Neil J. Bershad, Newport Beach, CA (US); Anurag Bist, Irvine, CA (US); Stan Hsieh, Diamond Bar, CA (US); James W. Mayer, Brea, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/154,185

(22) Filed: May 21, 2002

(51) Int. Cl. H04M 9/08

(52) U.S. Cl. 379/406.01; 379/406.08

(57) ABSTRACT

The invention provides a novel scheme for performing echo cancellation in the presence of double-talk and near-end channel impulse response changes. In one embodiment of the invention, a non-adaptive main filter is updated with the filtering weights of an adaptive shadow filter if the shadow filter cancels near-end echo in a first signal to a greater extent than the main filter. However, if double-talk is present in the first signal, then the non-adaptive filter is not updated. According to one embodiment of the invention, distinguishing between double-talk and channel impulse response changes is accomplished by maintaining extra taps for the main and shadow filters, in addition to taps employed by the main and shadow filters for echo canceling. The corresponding filtering algorithm weights for the additional taps of the main and shadow filters are compared to detect the onset of double-talk and/or channel impulse response changes.

### FIELD

One embodiment of the invention relates to an echo canceller that adapts to double-talk and channel impulse response changes to improve the quality of communication signals.

### BACKGROUND

Communication systems are often susceptible to acoustic feedback, also known as echo. Echo has the unwanted effect of causing double-talk in analog signals and phase-shift and corruption in digital signals. There are two kinds of echoes in communication systems, line echo and acoustical echo. Line echo typically arises when a voice signal received at a telephone leaks back into the transmission channel in the send path. Acoustical echo typically arises due to acoustic feedback. This may occur, for example, when the voice on a telephone speaker feeds into the microphone.

To counter the problems created by echo, echo cancellation filters, also referred to as echo cancellers, are often employed in communication systems. Generally, echo cancellers act to remove unwanted signals from a communication channel. For example, an echo canceller may be placed between a telephone or communication device and the communication network. The echo canceller serves to cancel or reduce near-end echo. Near-end echo may include any echo originating from the telephone or communication device closest to the echo canceller. For example, near-end echo may include line echo, acoustical echo, or a combination of both line and acoustical echo, caused by a far-end signal (a signal originating at a far-end device) that feeds back or leaks into the transmission channel of the communication device closest to the echo canceller.

Adaptive filters have become standard solutions for echo cancellation in communication systems. Many different types of adaptive algorithms may be employed for echo cancellation including least mean square (LMS), normalized LMS (LMS), and affine projection (AP) adaptation algorithms. Most adaptive filter implementations use these algorithms because they are robust and of low computational complexity. An echo-canceling algorithm or adaptive filter typically employs multiple adaptive weights or coefficients to generate an echo-canceling signal. The weights or coefficients serve to configure the echo-canceling algorithm to remove the echo signal at the appropriate time.

There are two non-trivial real world echo cancellation problems. The first problem is caused by double-talk. Double-talk signals are created by the simultaneous generation of signals (e.g., speech) from both the far-end and near-end ports (full-duplex communications) of a communication system. An echo canceller typically filters an affected signal by subtracting the echo caused the interfering signal. A filtering algorithm is typically employed to predict or anticipate the echo contributed by the interfering signal and remove or decorrelate it from the affected signal.

The second problem is caused by changes in the communication channel which affects channel impulse response. For example, four-wire to two-wire conversions are typical in telephone communication channels. Four wires typically carry digital signals to and from a telephone or communication device. Before reaching the telephone device the digital signals are typically converted to analog by an analog-to-digital converter. Between the analog-to-digital converter and telephone device, signals are carried over two wires in analog form. However, the two-wire to four-wire conversion results in impedance mismatches and introduces signal reflections into the communication system. The channel impulse response may change when a second telephone is picked-up at one end, e.g. a different impedance is introduced.

These problems, double-talk and channel impulse response changes, require opposite behavior on the part of the echo canceller. Double-talk requires that the adaptive weights in an echo canceling algorithm be frozen (no adaptation) whereas changes in channel impulse response requires quick adaptation of said weights to said changes. Thus, an echo canceller should be able to detect the difference between the two conditions and adapt accordingly.

### BRIEF DESCRIPTION OF THE DRAWINGS

FIG. 1 is a block diagram illustrating one embodiment of an echo canceller capable of distinguishing between double-talk and channel impulse response changes according to one embodiment of the invention.

FIG. 2 is a flow diagram illustrating a general method for adjusting the operation of an echo canceller based on the detection or non-detection of double-talk according to one embodiment of the invention.

FIGS. 3 and 4 are block diagrams illustrating how the echo canceller of FIG. 1 may be configured in alternate embodiments of the invention to provide early detection of double-talk and/or channel impulse response changes.

FIG. 5 illustrates a communication system in which an echo canceller, according to one embodiment of the invention, is employed.

### DETAILED DESCRIPTION OF THE INVENTION

In the following detailed description of the invention, numerous specific details are set forth in order to provide a thorough understanding of the invention. However, the invention may be practiced without these specific details. In other instances well known methods, procedures, and/or components have not been described in detail so as not to unnecessarily obscure aspects of the invention.

In the following description, certain terminology is used to describe certain features of one or more embodiments of the invention. For instance, the term ‘filter’ includes any electronic device that modifies a signal and/or communication channel. Also, the term ‘filter configuration’ includes filter coefficients and/or weights. The term ‘adapt’ (e.g., filter adaptation) is hereinafter used interchangeably with such terms as ‘modify’, ‘update’, ‘configure’, and ‘reconfigure’.

Various embodiments of the invention address the problem of line echo (and/or acoustical echo) and its removal. One aspect of the invention provides a novel adaptive echo cancellation scheme capable of quickly detecting echo during double-talk as well as channel impulse response changes, distinguishing between the two, and stopping or continuing adaptation as necessary.

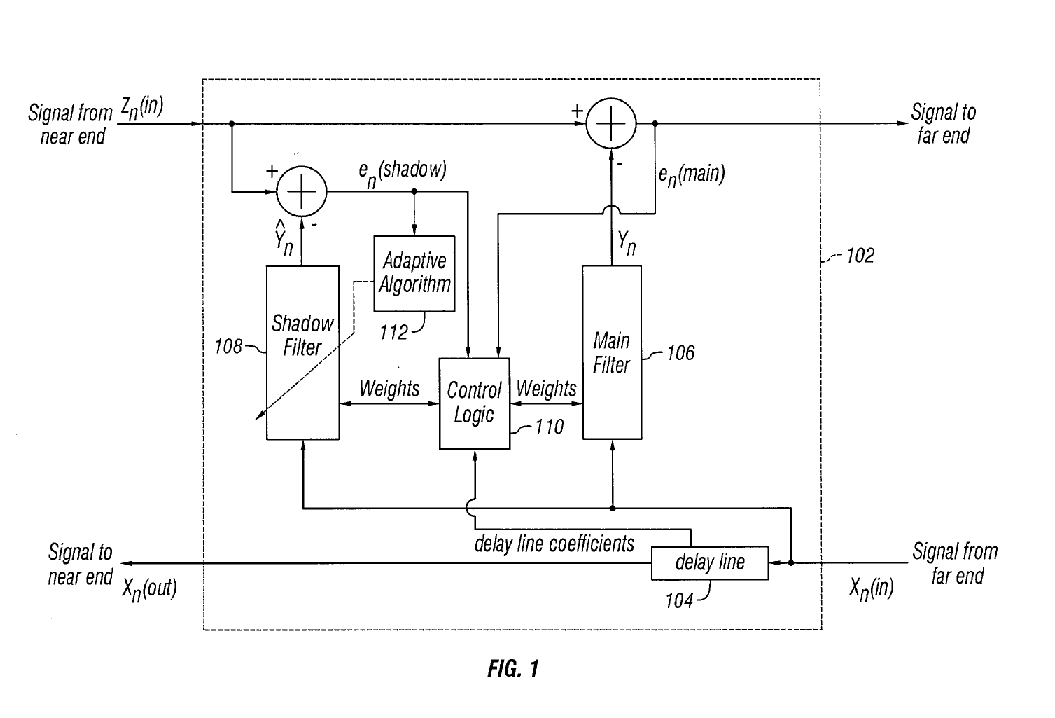

FIG. 1 is a block diagram of an echo cancellation filter 102 according to one embodiment of the invention. This echo canceller 102 may be employed in a communication network to cancel echo. The echo canceller 102 may be located somewhere between, and/or within, an end-point device (e.g., telephone) and the local access to the communication network (e.g., local central office).

Generally, an echo canceller according to an embodiment of the invention may be placed or located anywhere between a telephone or communication device and a point of access to a communication network. In one embodiment of an echo canceller implementing the invention, echo cancellation is performed on digital signals. Such echo canceller may operate on linear signals (16-bit linear signals); however, the input to the echo canceller may be time division multiplexed (TDM, e.g., A-law/Mu-law 8-bit signals) or in packet format. If the input is in packet format, it may need to be decoded into 16-bit linear signal before feeding it to the echo canceller.

In the embodiment of the invention shown in FIG. 1, the echo canceller 102 includes a delay line 104, to receive signals (e.g., binary packets or symbols, digital signals, etc.) from a far-end device and delay it by a certain amount of time, a non-adaptive main filter 106, to generate an echo compensation signal based on non-feedback filter weights, an adaptive shadow filter 108 to generate an echo compensation (cancellation) signal based on feedback-modified filter weights or coefficients, and a control logic 110 to transfer, update, and/or reset filter algorithm weights for the main filter 106 and/or shadow filters 108 depending on perceived or detected operating conditions.

The delay line 104 may delay the received signal Xₙ (in) in a number of ways. For instance, since the signal received Xₙ (in) is digital (e.g., may be represented as binary symbols), the delay line 104 may be a first-in first-out shift buffer of length N, where N is a positive integer. After the delay line 104, the signal Xₙ (out) passes to its intended destination, the near-end device.

A non adaptive main filter 106 and an adaptive shadow filter 108 receive signal Xₙ (in). The main filter 106 and shadow filter 108 may both be configured with the same filter structure (e.g. tapped delay line, lattice, etc.). In some embodiments of the invention, a signal delay of signal Xₙ (in) may be implemented within the main and shadow filters 106 and 108. In other embodiments of the invention, neither the main filter 106 nor the shadow filter 108 delay the received signal Xₙ (in) or Xₙ (out), but instead rely on an external delay element.

The non-adaptive main filter 106 filters the input Xₙ (in) to generate a compensation signal Yₙ which is subtracted (removed) from the returning signal Zₙ (in), from the near-end device, to compensate for echo contributed by the transmitted signal Xₙ (out). In this embodiment of the invention, the returning signal Zₙ (in) may or may not contain echo at some given time, depending upon the presence of a far-end signal Xₙ (in) and the characteristics of the near-end device echo-channel.

As employed herein, the term non-adaptive refers to a filter which algorithm weights are not regularly and/or automatically modified as a result of a single feedback error signal. However, the non-adaptive filter weights or coefficients may be updated, reset, and/or configured as a result of decisions made from the comparison or use of multiple error signals (at least one of which is an external error signal not generated by the non-adaptive filter) or calculated metrics.

The adaptive shadow filter 108 also filters signal Xₙ (in) to generate a compensation signal Ŷₙ which is adjusted based on a feedback signal eₙ (shadow). In one implementation, an adaptation controller or adaptive algorithm 112 receives a feedback signal eₙ (shadow) which is the error signal for the combination of signals Zₙ (in)-Ŷₙ. The adaptation controller or adaptive algorithm 112 then adjusts the shadow filter weights in order to minimize the echo component of signal Zₙ (in). The shadow filter weights or coefficients serve to weight the input data or signal Xₙ (in) to generate a compensation signal with the characteristics necessary to reduce the echo present in Zₙ (in). For example, the filter weights account for the tail-end delay, the time signal Xₙ (out) passes the filter 102 to the time the signal's echo (included in signal Zₙ (in)) is received at the filter 102.

A control logic unit 110 receives feedback signals eₙ (main) and eₙ (shadow) as well as the coefficients for the delay line 104 in order to transfer, copy, update, and/or reset the filter weights of the main filter 106 and shadow filter 108 based on the perceived and/or detected operating conditions.

In one implementation, the magnitudes of signals eₙ (main) and eₙ (shadow) are periodically compared by the control logic 110. If the magnitude of eₙ (main) is less than the magnitude of en (shadow), the main filter 106 continues to employ the same set of filter weights. If the magnitude of eₙ (main) becomes greater than eₙ (shadow), then the control logic 110 updates the filter weight for the main filter 106 by copying and transferring the filter weights from the shadow filter 108 into the main filter 106.

However, there are two problems with employing this scheme under different operating conditions.

Double-talk is an operating condition where communications occur concurrently or simultaneously from both ends. Under these conditions, the near-end signal Zₙ (in) would typically contain both a voice signal, originating from the near-end device, and an echo signal, attributed to Xₙ (out). With the addition of voice to the incoming signal Zₙ (in), the shadow filter would adapt, via its feedback adaptation algorithm 112, to reduce the magnitude of eₙ (shadow). The signal eₙ (shadow) would become smaller than eₙ (main). However, under double-talk conditions, it is undesirable to have the control logic 110 copy the filter weights or coefficients from the shadow filter 108 to the main filter 106; doing so would cause the adapted weights or coefficients of the main filter 106 to be destroyed and result in increased residual echo. Additionally, double-talk can be difficult to detect when the voice signal is faint in comparison to the echo signal. Where double-talk occurs, rather than update the main filter's weights, it would be best for the main filter to operate using the weights it had prior to the onset of double-talk. This would allow the main filter 106 to remove the echo signal without inhibiting or degrading the near-end voice signal.

Changes in the channel impulse response have a different effect in the operation of the echo canceller 102. As previously mentioned, a channel's impulse response may change for several reasons. For instance, if a second telephone device is picked-up at the near-end while a first telephone device is already in use at the near-end, or a user switches from a first telephone to a second telephone, this may cause the channel impulse response to change. Another cause for a change in channel impulse response may be where the central office switches transmission lines or mediums to the near-end device during a given conversation. A channel impulse change typically affects or changes the characteristics of echo signals on said channel. For instance, the echo signal may increase in power. Thus, where the echo signal changes as a result of a channel impulse response change, the echo compensation signal Yₙ should change to provide effective echo cancellation.

Where channel impulse changes occur, it would be desirable for the main filter weights to also change, or be updated, so that an appropriate echo compensation (cancellation) signal Yₙ can be generated. However, distinguishing between double-talk and channel impulse response changes is a difficult task for an echo canceller. In particular, it often takes several signal samples for the echo canceller to determine whether double-talk is present or channel impulse response has changed. Without the present invention, during the time it takes an echo canceller to determine whether double-talk or channel impulse response changes have occurred, the shadow filter would have adapted its filter weights, and the main filter may have updated its filter weights based on the shadow filter's adaptation. If double-talk were occurring, this would cause the voice signal to be disrupted since the main filter would be filtering/cancelling both the echo signal and voice signal. On the other hand, delaying the updating of the main filter weights until the echo canceller determines whether a double-talk or channel impulse response change has occurred would also cause disruption in the quality of the communications. If the channel impulse response had changed, continued use of the main filter weights while the operating condition is ascertained may allow echo signals to pass through unfiltered.

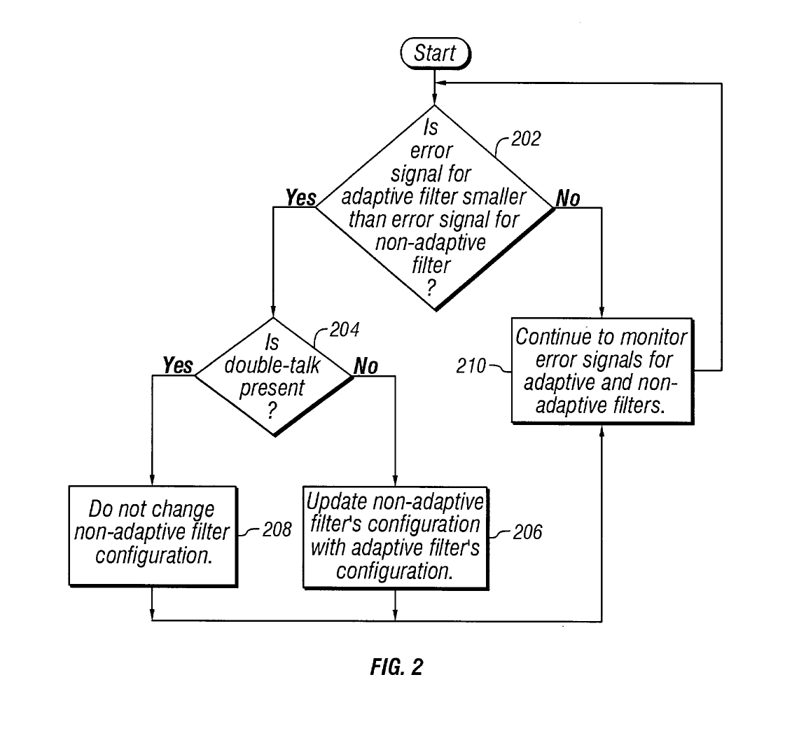

FIG. 2 illustrates the general method for adjusting the operation of an echo canceller based on the detection or non-detection of double-talk according to one embodiment of the invention. An echo canceller (e.g., 102 in FIG. 1) compares the error signals for an adaptive shadow filter (e.g., 108) and non-adaptive main filter (e.g., 106) 202. This may be accomplished by comparing the signal power of the error signals. If the adaptive filter has a smaller error signal then the non-adaptive filter, then it is determined whether the signal being filtered contains double-talk 204. If double-talk is not present, then the non-adaptive filter's configuration (e.g., main filter weights) is replaced with the adaptive filter's configuration (e.g., shadow filter weights) 206 to improve echo cancellation by the non-adaptive filter. If double-talk is present, then the non-adaptive main filter weights, coefficients, or configuration are not changed 208 since doing so would cause filtering of non-echo portions of the signal being filtered. The error signals for the adaptive and non-adaptive filter are monitored to detect changes 210.

According to one embodiment of the invention, additional taps, in excess of the number of taps employed by the filtering algorithm, are maintained by the shadow and main filters (e.g., 108 and 106 in FIG. 1) to permit early detection of double-talk and/or channel impulse response changes.

While various different adaptive cancellation algorithms may be employed by an echo canceller, such as least mean square (LMS), normalized LMS, and affine projection (AP), all these algorithms typically include multiple taps (the use of multiple data points at any one time to generate an echo cancellation signal). Taps permit an algorithm to provide a delayed compensation (echo cancellation) signal (e.g., Yₙ and Ŷₙ in FIG. 1). Generally, the larger the number of taps, the larger the range of time or tail-end delays an echo cancellation algorithm can compensate. For example, a five hundred twelve (512) tap structure may be able to compensate for a time or tail-end delay of up to five hundred twelve symbols or, alternatively, time or tail-end delay delays of up to 64 milliseconds. That is, the five hundred twelve tap algorithm is able to provide an echo cancellation signal Y_{q} corresponding to a signal symbol X_{q} that first passed the echo canceller up to five hundred twelve symbols ago or 64 milliseconds ago, for instance.

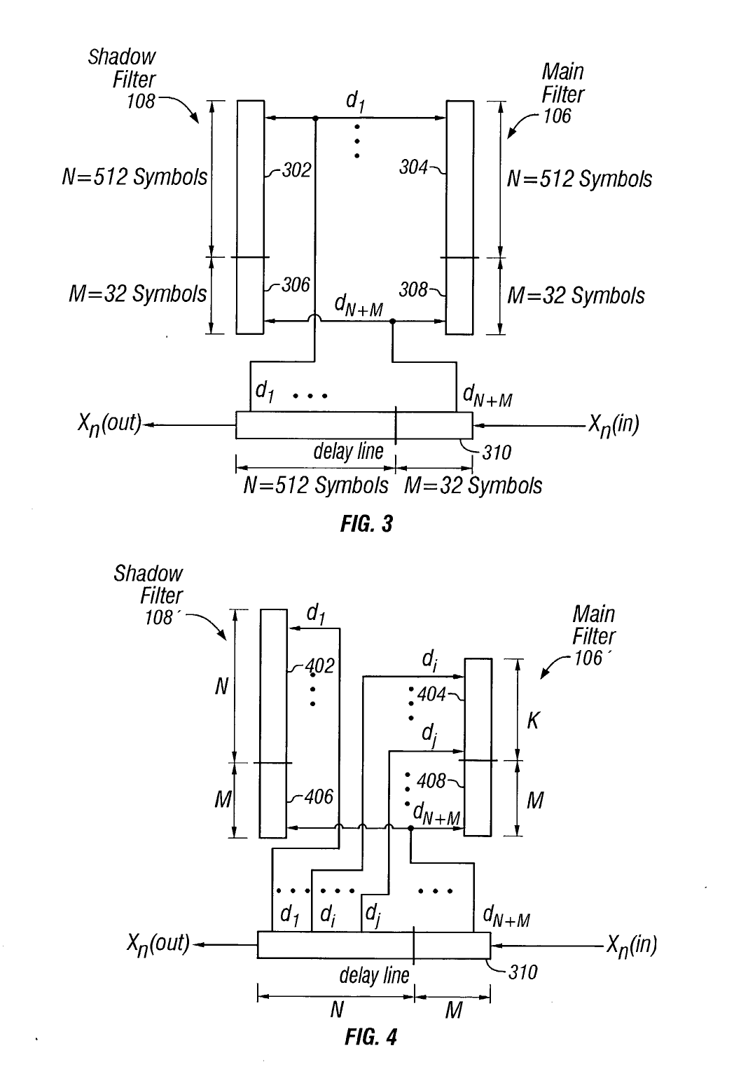

FIG. 3 illustrates how, in the embodiment of the invention illustrated in FIG. 1, additional taps, in excess of those used by conventional main and shadow filter structures, may be employed. In this embodiment of the invention, the filter structure utilized by the main and shadow filters 106 and 108 employs N+M taps or symbols (e.g., N=512 taps, M=32 taps) 302 & 306 and 304 & 308 to generate compensation signals Yₙ and Ŷₙ respectively (shown in FIG. 1). In this illustration, only a filter structure N taps long 302 or 304 is necessary to generate a compensation signal Yₙ or Ŷₙ for a given tail-end delay. The additional M taps or symbols 306 and 308 are maintained by the filters 106 and 108 to permit early detection of double-talk and/or channel impulse response changes. Note that the number of additional taps or symbols 306 and 308 correspond to an additional delay, M taps long 310, created by the delay line. The delay line may be used to capture the tail-end delay of the echo that may occur, for example, anywhere from approximately zero (0) milliseconds to sixty-four (64) milliseconds for a five hundred twelve (512) tap filter. The M additional taps 306 and 308 are taps in excess of the taps employed and/or necessary for the echo filter structure to provide time (tail-end) delay compensation. Thus, while a filter structure may employ the full N+M taps, only N taps are necessary to generate a compensation signal. In yet other embodiments of the invention, the filter structure utilized by the main and shadow filters 106 and 108 employs just N taps or symbols (e.g., N=512 taps) 302 and 304 to generate compensation signals Yₙ and Ŷₙ respectively (shown in FIG. 1).

The M additional taps 306 and 308 may be employed in a number of ways to determine the onset of double-talk and/or a channel impulse response change. In one embodiment of the invention, these additional taps occur at the very beginning of the filter.

That is, as illustrated in FIG. 3, the taps or data points d₁. . . d_{N+M} are transferred to the filters 106 and 108 in the order illustrated, first-in first-out.

At the onset of double-talk, the additional M taps 306 and 308 are the taps that are corrupted first. Such corruption would be indicated by increased relative energy of these data points. In one implementation, no new filtering method is employed for filtering these additional taps.

One or more metrics may be calculated, from the additional M taps of the main filter 106 and shadow filter 108, to distinguish between the onset of these two different conditions before the main filter 106 has filtered the signal Zₙ (in). A metric may be any indicator, value, and/or gauge that is indicative of the different signal and/or operating conditions. In one implementation, the one or more metrics may be employed to control the transfer of weights or coefficients from shadow filter 108 to main filter 106 depending on whether or not double-talk is present.

For example, if each of the M additional taps are represented by corresponding algorithm weights Wₘ, where m is an integer from 0 to 31, then a metric B may be calculated as follows:

Bₜₒₜ=Σ(Wₘ²), for m=0 to 31;

$${B}_{aveg} = {B}_{tot} \times ( \frac{32}{32 + tap\_length} ) ,$$

for tap_length being the length of the filtering taps (e.g., tap_length=512 symbols in the main filter 106 shown in FIG. 3).

In one implementation, the ‘m’ weights employed to calculate the comparison metrics (e.g., B_{aveg} (main) and B_{aveg} (shadow) ) correspond to the most recently received signal symbols Xₙ (in). These additional taps may be located at the beginning of the filter such that they are updated first. In one implementation, these additional taps are updated first. It can then be determined whether or not double-talk is present, for instance, by monitoring one or more metrics (e.g., B_{aveg} (main) and B_{aveg} (shadow) ). If double-talk is present, the transfer of weights (coefficients) from the shadow filter to the main filter can be disabled or suspended.

The metrics may be employed in various ways in deciding whether or not to update or replace the main filter weights, Wₘₐᵢₙ, with the shadow filter weights, W_{shadow}. For example, in one implementation, the main filter weights Wₘₐᵢₙ are updated with the shadow filter weights W_{shadow} only if

B_{shadow}<Bₘₐᵢₙ, and

eₙ(shadow)<eₙ(main),

where Bₘₐᵢₙ and B_{shadow} are metrics calculated using the filter weights corresponding to the M additional taps (taps not employed for echo cancellation) for the shadow and main filters respectively; eₙ (shadow) and eₙ (main) represent the respective error signals (or the power of the error signals) for the shadow and main filter. In one implementation, the metrics Bₘₐᵢₙ and B_{shadow} are averaged metrics (e.g., B_{aveg} (main) and B_{aveg} (shadow) respectively) based on m filter weights (where m is an integer). The m filter weights correspond to filter taps not employed by the echo filtering algorithm and/or in excess of those taps needed by the echo filtering algorithm for tail-end delay compensation.

These metrics may also be employed to distinguish between the onset of either double-talk or channel impulse response change.

For example, in one implementation of the invention, the main filter metric Bₘₐᵢₙ and shadow metric B_{shadow} are compared using the following parameters:

| | |
|---|---|
| P1: Bₘₐᵢₙ ≧ B_{shadow} | (True(1)/False(0)) |
| P2: B_{shadow} > N × Bₘₐᵢₙ | (True(1)/False(0)) |
| P3: Bₘₐᵢₙ ≧ B_{shadow}_{_{—}}_{new} | (True(1)/False(0)) |
| P4: double_talk_flag | (True(1)/False(0)) |
| P5: eₘₐᵢₙ² ≧ K × e_{shadow}² | (True(1)/False(0)) |

where N is an integer value (e.g. N=2), K is an integer value (e.g. K=50), double_talk_flag is False(0) if there is no double-talk detected. Additionally, eₘₐᵢₙ is the averaged error signal for m previous signal samples and e_{shadow} is the averaged error signal for h previous signal samples, where m and h are positive integers. In one implementation, m and h are the same number. Lastly, B_{shadow} and Bₘₐᵢₙ are metrics (e.g., B_{aveg} (shadow) and B_{aveg} (main)) calculated using the additional weights corresponding to the M additional taps 206 and 208.

The state (e.g., True/False) of the double_talk_flag may be determined by comparing the relative energies of far-end and near-end signals. Both long-term averages and/or short-term averages may be used. When the near-end signal average energy becomes a fraction of far-end average energy (e.g., both long-term and short-term averages, for instance), the double-talk_flag is set to True(1).

According to one scheme, if P1, P3, P4, P5 are all True(1) then the shadow filter weights W_{shadow} are copied to the main filter (Wₘₐᵢₙ=W_{shadow}). That is, the parameters indicate that no double-talk is present (double_talk_flag=0) and, likely, there has been a change in the channel impulse response. Therefore, the main filter weights should be updated or replaced with the corresponding shadow filter weights. Conversely, if P2 is True (1) and P1, P3, P4, P5 are all False (0) then the main filter weights Wₘₐᵢₙ are copied to the shadow filter (W_{shadow}=Wₘₐᵢₙ). That is, the parameters indicate that double-talk is likely present (double_talk_flag=1). Therefore, the shadow filter weights may be updated or replaced with the main filter weights. In one implementation, the shadow filter weights need not be updated if double-talk is detected.

The metrics and/or parameters illustrated above, as well as other types of metrics, parameters, and/or flags, may be employed in various configurations to distinguish between double-talk and channel impulse response changes without departing from the invention.

FIG. 4 illustrates another embodiment of the invention where the main and shadow filters 106′ and 108′ have different tap lengths and may be employed in the echo canceller illustrated in FIG. 1. In particular, the shadow filter has a longer tap length than the main filter (N>K). The adaptive shadow filter 108′ has a sufficient number of taps (say N) to cover the full range of possible channel delays and impulse responses. It is fully adaptive and, as described with reference to FIG. 1, its output is used to generate an error signal for the adaptation algorithm. This is a novel application of the shadow filter concept and is the opposite of the typical use of a shadow filter. The shadow filter is usually shorter than the main channel filter so as to be able to adapt quickly during single-talk (where only a far-end voice signal is present).

As illustrated in FIG. 4, the shadow filter 108′ may employ the full range of taps (e.g., tap length N+M) provided by the delay line 310 (e.g., data points d₁ through d_{N+M}). However, the main filter 106′ employs a shorter tap length K which includes a subset of the total taps (e.g., data points dᵢ through dⱼ, where i and j are integer values). This configuration may permit faster updating of the main filter 106′ where the tail-end delay has been identified. Thus, the taps dᵢ through dⱼ can be selected to correspond to the tail-end delay.

The specific transferred shadow filter weights depend upon the class of echo-channels. The channels may be classified as 1) single peaked of width L₁, 2) multiple peaked of width L₁ and 3) sparse with several widely separated peaks, each of width L₂, where L>>L₁, I=1, 2 (where L is the overall channel width). Different channels behave differently during adaptation and have different cancellation properties. For an echo canceller implementation to be robust, it is desirable that an echo canceller behaves well in all channel conditions.

The echo canceller can be modified to handle sparse impulse responses and impulse responses that are short relative to the channel delay uncertainties. Since, generally, the peaks of impulse responses are few and sparse, it helps to have an implementation that utilizes these properties of the channel impulse response. This helps in computational complexity as well as improving the overall cancellation. The above mentioned aspects and techniques of the present invention may be applied even to a sparse filtering implementation.

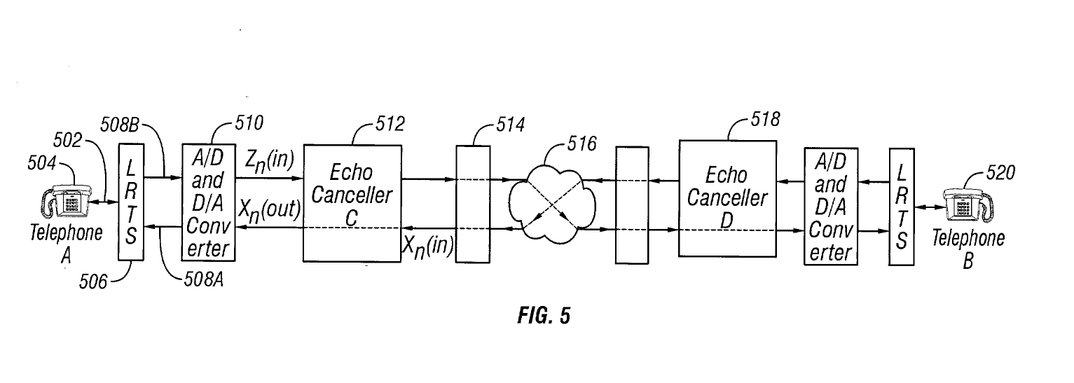

FIG. 5 illustrates a communication system in which an echo canceller 512 or 518 according to the present invention may be employed to cancel echo. Twisted-pair lines 502 are commonly employed to carry analog voice communications to and from a telephone 504. Often times, a line receive/transmit switch (LRTS) 506 may be employed to convert the two wire twisted-pair lines 502 to four wires 508A and 508B, one pair of wires 508A to carry signals to the telephone 504 and the other pair or wires 508B to carry signals from the telephone A 504. Typically, communication networks transmit signals in digital form. Thus, analog signals are converted into digital signals at an analog-to-digital converter 510. An echo canceller C 512, according to one embodiment of the invention, lies between the analog-to-digital converter 510 and central office connection 514 to the main communication network 516. The echo canceller C 512 serves to cancel echo originating from telephone A 504 (echo caused by a far-end signal from telephone B 520 that feeds back or leaks into the transmission channel 508B of telephone A 504) while adjusting and distinguishing between double-talk and channel impulse response changes. A second echo canceller D 518 may be employed at a second end to similarly filter echo originating from telephone B 520.

The amount of near-end or tail-end delay may vary and the echo canceller 504 tail length may be selected to permit canceling varying delays. Near-end or tail end delay is the length of time it takes for a signal's echo to reach the echo canceller 512 on line 508B from the time the corresponding signal originally passed the echo canceller 512 on line 508A. That is, for a signal originating at telephone B 520, the tail-end delay is the total time between when the signal passes echo canceller C 512 on line 508A and its echo (if any) is received by echo canceller C 512 on line 508B. Depending on the location of the echo canceller 512 within the communication system, the tail-end delay is typically anywhere from a few milliseconds up to sixty-four (64) milliseconds or one-hundred twenty-eight (128) milliseconds.

Because the tail-end delay may vary in different implementations, the echo canceller 512 is designed to delay its compensation signal until the arrival of the echo signal.

While certain exemplary embodiments of the invention have been described and shown in the accompanying drawings, it is to be understood that such embodiments of the invention are merely illustrative of and not restrictive on the broad invention. This invention is not limited to the specific constructions and arrangements shown and described, since various other modifications may occur to those ordinarily skilled in the art. For example, various configurations or embodiments of the adaptive echo canceller may be employed for line echo cancellation, acoustical echo cancellation, and/or a combination thereof. Additionally, it is possible to implement the invention or some of its features in hardware, programmable devices, firmware, software or a combination thereof. The invention or parts of the invention may also be embodied in a processor-readable storage medium or machine-readable medium such as a magnetic, optical, or semiconductor storage medium.

What is claimed is:

1. An apparatus comprising:
a non-adaptive filter configurable by a first set of weights to perform echo cancellation on a first signal;
an adaptive filter configurable by a second set of weights to perform echo cancellation on the first signal; and
a control logic coupled to the adaptive and non-adaptive filters, the control logic to receive a first error signal corresponding to the non-adaptive filter, and a second error signal corresponding to the adaptive filter, and replace the first set of weights in the non-adaptive filter with the second set of weights if the first error signal has a lower signal power than the second error signal.

2. The apparatus of claim 1 wherein the control logic replaces the adaptive filter weights with the non-adaptive filter weights if a change in channel impulse response is detected.

3. The apparatus of claim 1 wherein if double-talk is detected the control logic suspends replacement of the non-adaptive filter weights before portions of the first signal are cancelled by the non-adaptive filter.

4. The apparatus of claim 1 wherein the non-adaptive filter is K taps long and the adaptive filter is N taps long, where N and K are integers, the non-adaptive and adaptive filters are each maintain an additional M taps, in excess of those necessary for echo cancellation, the additional M taps to permit the early detection of double-talk before portions of the first signal are cancelled by the non-adaptive filter.

5. The apparatus of claim 4 wherein a third set of weights corresponding to the M additional taps for the non-adaptive filter are employed to generate a first metric, a fourth set of algorithm weights corresponding the M additional taps for the adaptive filter are employed to calculate a second metric, the first and second metrics are compared to determine if and when the first set of weights are replaced by the second set of weights.

6. The apparatus of claim 4 wherein K is less than N.

7. The apparatus of claim 6 further comprising:
a delay line coupled to the non-adaptive filter and adaptive filter, the delay line to delay an incoming signal by an amount corresponding to M taps plus N taps, and then pass the incoming signal to the non-adaptive filter and adaptive filter.

8. The apparatus of claim 1 further comprising:
an adaptation controller coupled to the adaptive filter, the adaptation controller to receive the second error signal and update the second set of weights for the adaptive filter to minimize the signal power of the second error signal.

9. The apparatus of claim 1 wherein the adaptive filter implements an affine projection algorithm to minimize near-end echo in the first signal.

10. The apparatus of claim 1 wherein the adaptive filter implements a normalized least mean square algorithm to minimize near-end echo in the first signal.

11. A device comprising:
non-adaptive filtering means for canceling echo in a first signal;
adaptive filtering means for canceling echo in the first signal; and
control means for detecting double-talk in the first signal and updating the non-adaptive filtering means according to the configuration of the adaptive filtering means if no double-talk is present but, if double-talk is present, locking the non-adaptive filtering means' configuration before portions of the first signal are cancelled by the non-adaptive filtering means, the control means being coupled to coupled to the non-adaptive filtering means and the adaptive filtering means.

12. The device of claim 11 further comprising:
filter adaptation means for adapting the configuration of the adaptive filtering means based on a feedback signal so as to improve the echo canceling performance of the adaptive filtering means, the filter adaptation means coupled to the adaptive filtering means.

13. The device of claim 11 wherein the non-adaptive filtering means has fewer taps employed for canceling near-end echo than the adaptive filtering means.

14. A method comprising:
determining if double-talk is present in a first signal;
replacing a first set of filter weights for a non-adaptive filter with a second set of filter weights for an adaptive filter if double-talk is not present and the second set of weights cancel echo in the first signal to a greater extent than the first set of weights; and
suspending replacement of the first set of weights before portions of the first signal are filtered by the non-adaptive filter if double-talk is present.

15. The method of claim 14 wherein determining if double-talk is present includes
maintaining M taps in addition to the N taps necessary for the adaptive echo filter to perform echo cancellation, the additional M taps adapted by the same algorithm as the N echo filtering taps, where M and N are integers,
maintaining M taps in addition to the K taps employed by the non-adaptive echo filter for echo filtering, where K is an integer,
calculating a first metric based on a third set of weights corresponding to the M taps for the adaptive filter,
calculating a second metric based on a fourth set of weights corresponding to the M taps for the non-adaptive filter, and
comparing the first metric to the second metric to determine if double-talk is present.

16. The method of claim 14 wherein K is greater than N.

17. The method of claim 14 wherein the adaptive filter and the non-adaptive filter implement an affine projection filtering algorithm.

18. The method of claim 14 wherein the adaptive filter implements a normalized least mean square filtering algorithm.

19. The method of claim 14 wherein the first signal is a digital signal for voice communications and the non-adaptive echo filter and adaptive echo filter are employed for near-end echo cancellation.

20. The method of claim 14 further comprising:
distinguishing between double-talk and channel impulse response changes.

21. A machine-readable medium having one or more instructions for controlling the operation of an echo canceller, which when executed by a processor, causes the processor to perform operations comprising:
detecting double-talk in a first signal;
replacing a non adaptive filter's first configuration according to a second filter's configuration if no double-talk is present and the second filter's configuration cancels echo in the first signal to a greater extent than the non-adaptive filter's configuration; and
suspending replacement of the first configuration if double-talk is present before portions of the first signal are cancelled by the non-adaptive filter.

22. The machine-readable medium of claim 21 having one or more instructions which cause the processor to further perform operations comprising:
distinguishing between double-talk and channel impulse response changes before portions of the first signal are cancelled by the non-adaptive filter.

23. The machine-readable medium of claim 21 having one or more instructions which cause the processor to further perform operations comprising:
obtaining the second filter's configuration from an adaptive filter.

24. The machine-readable medium of claim 21 wherein detecting double-talk in the first signal a first set of weights, corresponding to a first set of N taps for the non-adaptive filter, and a second set of weights, corresponding to a second set of N taps for an adaptive filter, are compared, where N is an integer, the first and second sets of taps are taps which are not necessary for the adaptive and non-adaptive filters to perform echo cancellation.

25. The machine-readable medium of claim 24 having one or more instructions which cause the processor to further perform operations comprising:
calculating a first metric based on the first set of weights for the non-adaptive filter,
calculating a second metric based on the second set of weights for the adaptive filter, and
comparing the first metric to the second metric to determine if double-talk is present.

26. The machine-readable medium of claim 24 wherein the non-adaptive filter includes fewer taps than the adaptive filter for performing echo filtering.

27. The machine-readable medium of claim 21 wherein the first filter configuration and second filter configuration are weights for a filter structure.
